(19) United States
(12) Patent Application Publication
(10) Pub. No.: US 2007/0284460 A1
(43) Pub. Date: Dec. 13, 2007

(54) Pull-out kitchen sprayer

(75) Inventor: Orlando Bosio, Casaloldo (IT)

Correspondence Address: MODIANO & ASSOCIATI, Via Meravigli, 16, MILAN, 20123, omitted

(73) Assignee: AMFAG S.p.A.

(21) Appl. No.: 11/802,605

(22) Filed: May 24, 2007

(30) Foreign Application Priority Data
May 29, 2006 (IT) MN2006A000041

(51) Int. Cl. A62C 31/00

(52) U.S. Cl. 239/449; 239/588; 239/525

(57) ABSTRACT

A pull-out kitchen sprayer connected to a flexible water supply hose and comprising a wall which can be gripped and is provided with a water outlet at one end, a coupling for connection to the flexible hose being arranged at the wall.

The present invention relates to a pull-out kitchen sprayer.

### BACKGROUND OF THE INVENTION

It is known that so-called kitchen sprayers, which are connected to a flexible hose so that they can be pulled out from faucets in order to reach distant positions within sinks and convey water, normally with the possibility to provide the outflow of the water as a central jet or as a peripheral jet by acting on an appropriately provided switching device, have become widespread.

### SUMMARY OF THE INVENTION

The aim of the present invention is to provide a pull-out kitchen sprayer which has improved characteristics with respect to currently commercially available sprayers.

The proposed aim is achieved by a pull-out kitchen sprayer according to the invention, which is connected to a flexible water supply hose and comprises a wall which can be gripped and is provided with a water outlet at one end, characterized in that the coupling for connection to the flexible hose is arranged at said wall.

### BRIEF DESCRIPTION OF THE DRAWINGS

Further characteristics and advantages of the present invention will become better apparent from the description of two preferred but not exclusive embodiments thereof, illustrated by way of non-limiting example in the accompanying drawings, wherein:

FIG. 1 is a view of the sprayer according to the invention, in inactive condition;

FIG. 2 is a view of the sprayer during use;

FIG. 3 is a view of a variation of the sprayer according to the invention.

### DESCRIPTION OF THE PREFERRED EMBODIMENTS

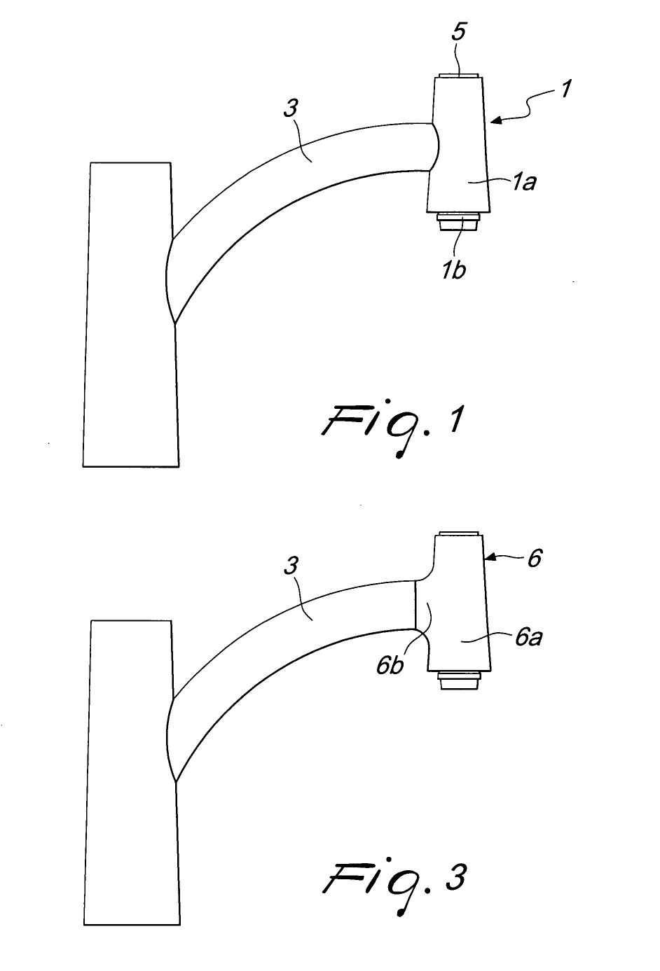

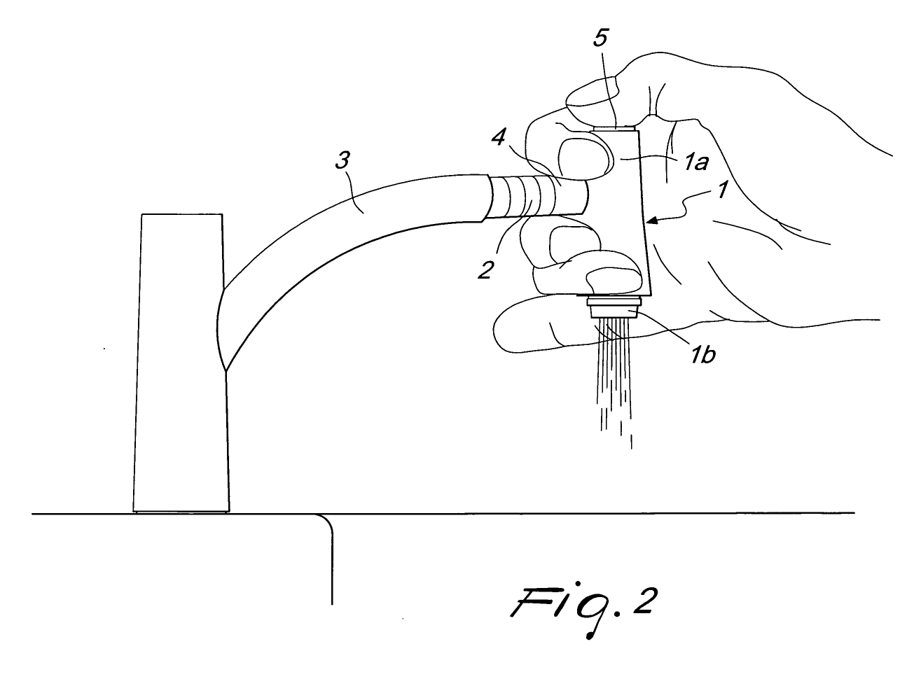

With reference to the FIGS. 1 and 2, the reference numeral 1 designates the sprayer fixed to the end of a flexible water supply hose 2, which can be pulled out of a tubular body 3 of a faucet which is designed to contain internally the flexible hose.

More specifically, a coupling 4 is provided which protrudes from the sprayer 1 for connection to the flexible hose 2, and the main feature of the invention consists in that the coupling 4 protrudes from the sprayer 1 at a hole which is provided at a grippable wall 1a of the sprayer.

The water flows out of the sprayer at an end 1b, and at the opposite end there is a button 5 for actuating the device for switching the conditions of outflow of the water from central jet to peripheral jet and vice versa.

FIG. 2 clearly shows how easy it is for the user to operate the sprayer according to the invention: after gripping the sprayer in optimum conditions, the user in fact pulls it out from the faucet with a gesture which is extremely natural and such as to move immediately the sprayer away from the faucet in order to reach distant regions of the sink.

FIG. 3 illustrates a variation of the sprayer according to the invention in which a grippable wall 6a of a sprayer 6 is provided, at the passage hole of the coupling for connection to the flexible hose located within the tubular body 3 of the faucet, with a connector 6b which matches the shape of the tubular body and can have any length.

In the practical embodiment of the invention, all the details may be replaced with other technically equivalent elements.

The disclosures in Italian Patent Application No. MN2006A000041 from which this application claims priority are incorporated herein by reference.

What is claimed is:

1. A pull-out kitchen sprayer connected to a flexible water supply hose and comprising a wall which can be gripped and is provided with a water outlet at one end, wherein a coupling for connection to the flexible hose is arranged at said wall.

2. The sprayer according to claim 1, comprising a device for switching outflow conditions of the water from a central jet to a peripheral jet and vice versa, wherein the wall has, at an end that lies opposite the water outflow end, a button for operating said switching device.

3. The sprayer according to claim 1, wherein the grippable wall has a hole for the passage of the coupling for connection to the flexible hose.

4. The sprayer according to claim 1, wherein the grippable wall has a connector of any length at a hole for the passage of the coupling for connection to the flexible hose.
